(19) United States
(12) Patent Application Publication
(10) Pub. No.: US 2003/0123433 A1
(43) Pub. Date: Jul. 3, 2003

(54) Random multi-character code generating system

(76) Inventor: Daniel E. Stafne, Shoreview, MN (US)

Correspondence Address: Lawrence M. Nawrocki, NAWROCKI, ROONEY & SIVERTSON, P.A., Broadway Place East, Suite 401, 3433 Broadway Street Northeast, Minneapolis, MN, 55413, US

(21) Appl. No.: 10/039,772

(22) Filed: Dec. 31, 2001

(51) Int. Cl. H04L 12/66; H04L 12/56

(52) U.S. Cl. 370/352; 370/395.1; 370/401

(57) ABSTRACT

A random multi-character code generating set of multi-faceted elements. The multi-faceted elements carry a plurality of indicia thereon. The elements include a first multi-faceted element carrying first indicia thereon and a second multi-faceted element carrying second indicia distinguishable from the first indicia thereon.

### BACKGROUND OF THE INVENTION

The present invention relates generally to the field of code generation. In particular, the present invention relates to random code generating systems.

The need for codes to protect property or information has been necessary in society for thousands of years. Coding has been used to maintain the secrecy of military information, financial information, and has been utilized in the locking mechanisms of security devices such as safes, alarms, passwords, etc.

In the past, most coding and password protection was needed within the government, and in those cases, coding specialists where utilized to develop random codes. In today's technological world, the use of codes to protect personal information, such as access to banking, voice or e-mail messages, security systems, etc., has made the need for random untraceable codes a subject of increasing interest to the general public.

Most individuals today utilize at least one coded password during their daily or weekly routine. Often times, individuals choose passwords from things that are familiar to them in their daily lives in order for them to more easily remember them and because they are easy for them to obtain for coding purposes. Examples of such things include the use of names of family members or pets, license plate numbers, birth dates, etc.

Along with the increase in the level of technology utilized for the security of our personal information has come similar increases in access to public information and technology based theft. With open access to many public records, criminals seeking to penetrate password protected information have a lot more information to enable them to overcome an individuals passwords. Therefore, the use of common information is also risky because of the possibility of it to appear in a public record available to criminals among the general public.

Additionally, since there is an increased risk of a security breach through continued use of a single password, it is typically recommended that the password be changed at regular intervals and that old passwords not be reused. Therefore, an individual will likely run out of common information as passwords in a short period of time.

Developments have been made to create systems for the creation of random code generators. Most of these developments have been made with the utilization of computers, wherein a computer program is designed to create a “random” character or set of characters. However, since a program is utilized to choose the code, the computer must follow the program in order to choose the character. Sophisticated criminals can review the program to learn the process in which the computer uses to choose the character. In this way, they are able to predict the character that is chosen and thereby determine the password generated by the program.

Computer based character generators also may be unavailable during power outages or when in remote locations. Accordingly, it has also been known to simply use dice to choose a number for use in creating a code. However, dice commonly available and suitable for defining a single character code element range from 4, 6, 8, or 10 and generally facets have the numbers 1-4, 1-6, 1-8 or 0-9 thereon. The use of these standard dice patterns for selecting codes is simple for a computer program to decipher since computers are adept at computing number sequences. Furthermore, number sequence codes are difficult for individuals to remember.

The present invention addresses these needs, as well as other problems associated with random code generating systems. The present invention offers advantages over the prior art and solves problems associated therewith.

### SUMMARY OF THE INVENTION

The present invention provides a random multi-character code generating system. It comprises a set of multi-faceted elements carrying a plurality of indicia thereon. The elements include a first multi-faceted element carrying first indicia thereon and a second multi-faceted element carrying second indicia distinguishable from the first indicia thereon. This use of the present invention is particularly useful, but not limited to, code and password generation, random time calculation, general randomization activities, and the like.

In one general embodiment at least some of the first indicia are alphabet symbols and some of the second indicia are numeric symbols. The elements also may have all of the first indicia being alphabet symbols and all the second indicia being numeric symbols.

In a more specific embodiment of the above embodiment, the first indicia are from the group of symbols consisting of: the 24 letter symbols present on a standard telephone keypad.

Other embodiments of the invention comprise elements having at least some of the first indicia from the group of symbols including the a combination of both the specialized letter symbols present in a second language, such as the Spanish language, and the letter symbols of a first language, such as English. This embodiment may also be comprised of elements having at least some second indicia that are numeric symbols.

Other embodiments of the present invention provide a multi-faceted element or elements that has the entire set of first or of both first and second indicia thereon and the number of facets being such that each facet has an equal surface area, thereby making the probability of selecting any of the indicia thereon equal. Probability can also be controlled by designing element sets wherein each indicia of a set of indicia appears on only one facet of a set of elements.

Depending upon the particular application for which the code generating system is utilized, specialized sets may be created for the particular intended purpose.

In applications where capital and lower case letters may be utilized, the present invention includes embodiments including means for determining the upper or lower case of letter symbols.

The present invention may also be utilized as a game for forming words and assessing points for scoring from indicia arranged on a set of multi-faceted elements carrying a plurality of indicia thereon. The game is comprised of a first multi-faceted element carrying first indicia and a second multi-faceted element carrying second indicia thereon. The first indicia include at least some language letter symbols. The second multi-faceted element carries second indicia whereby an amount of points can be assigned by the indicia.

The above mentioned benefits and other benefits of the invention will become clear from the following description by reference to the accompanying drawings.

### DESCRIPTION OF THE DRAWINGS

FIG. 1 provides embodiments of the invention having two facets and a sets of indicia including a truncated 24 letter alphabet in capitals and in lower case.

FIG. 2 provides embodiments of the invention having two facets and a combination set of indicia including truncated 24 letter upper and lower case alphabet symbols.

FIG. 3 provides embodiments of the invention having four facets and a set of indicia including a truncated 24 letter alphabet.

FIG. 4 provides embodiments of the invention having six facets and a set of indicia including a truncated 24 letter alphabet.

FIG. 5 provides embodiments of the invention having eight facets and a set of indicia including a truncated 24 letter alphabet.

FIG. 6 provides embodiments of the invention having twelve facets and a set of indicia including a truncated 24 letter alphabet.

FIG. 7 provides embodiments of the invention having twenty-four facets and a set of indicia including a truncated 24 letter alphabet.

FIG. 8 provides embodiments of the invention having six facets and a set of indicia including the full English alphabet and the 0-9 number set.

FIG. 9 provides embodiments of the invention having six facets and a set of indicia including the full English alphabet and specialized letters of the Spanish alphabet and a set of elements having ten facets and having the 0-9 number set thereon.

FIG. 10 provides embodiments of the invention having six facets and a set of indicia including a combination of the full English alphabet and the number set 0-9 thereon.

### DESCRIPTION OF THE PREFERRED EMBODIMENT

The present invention provides a random multi-character code generating system. It comprises a set of multi-faceted elements carrying a plurality of indicia thereon. The elements include a first multi-faceted element carrying first indicia thereon and a second multi-faceted element carrying second indicia distinguishable from the first indicia thereon.

A multi-faceted element may be any type of element, having indicia thereon, that may be manipulated in order to select one indicia. Some examples of such an elements include one or more multi-sided dice or two-sided tiles. Another example is a ball having indicia on the exterior and an internal mechanism for stopping the ball whereby a selection of an indicia can be made.

The sets of first and/or second indicia may be of any set known in the art that would be suitable for use in creating codes or any combination of one or more sets into a combination set. Most typically base ten number sets such as 0-9 and English language sets such as the complete alphabet or the 24 letter alphabet comprising those on a standard telephone keypad (a, b, c, d, e, f, g, h, i, j, k, l, m, n, o, p, r, s, t, u, v, w, x, y) are preferred. Some other suitable sets include any foreign language alphabet (such as Spanish, French, etc. or combinations of several alphabets), upper and lower case sets, font computer sets commonly utilized by computer programs, or any number symbol set (such as different base sets, Roman, Hebrew, binary, dots, or tallies, etc). Blank facets may also be used. First and second indicia may be distinguishable by any suitable means, such as, for example; different portions of a single alphabet, number or symbol set, different alphabets, different number systems, colors of numbers or elements, and the like.

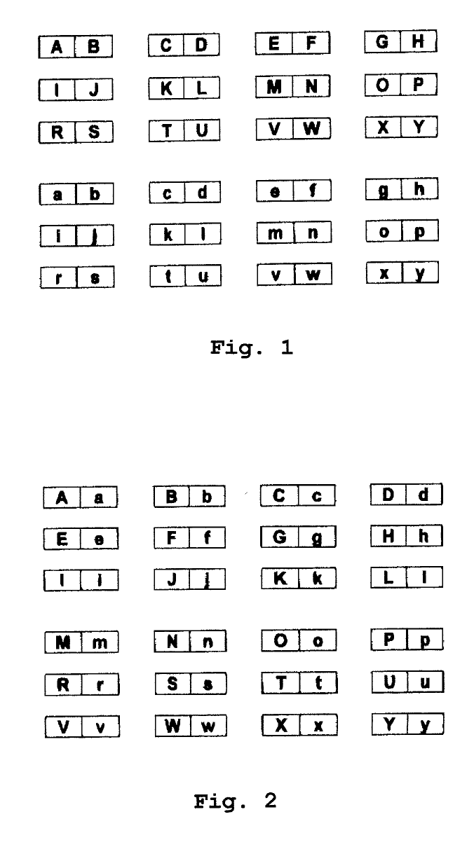

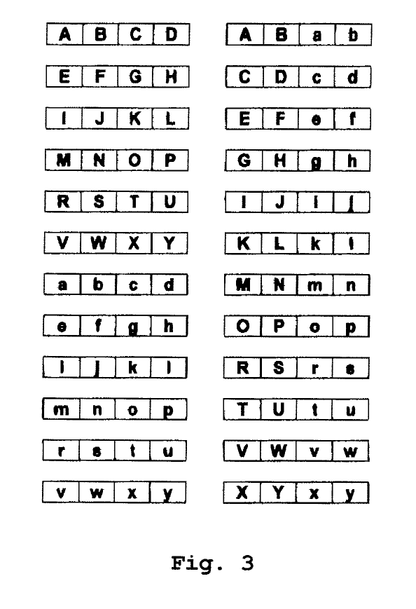

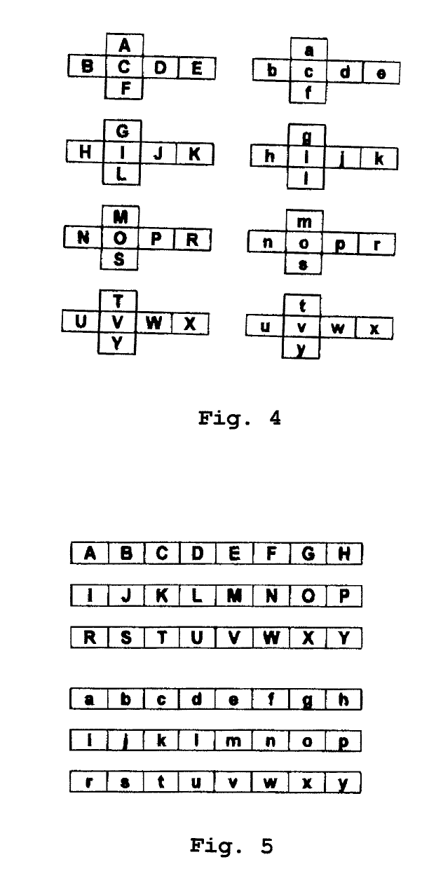

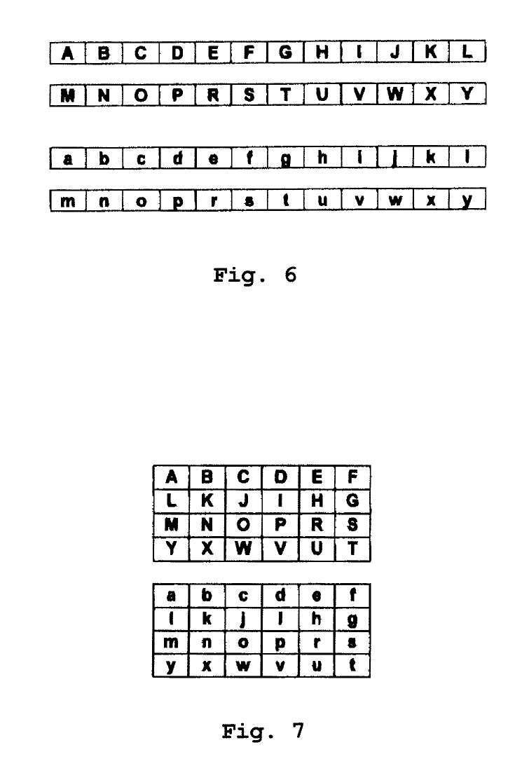

Examples of some English language sets are provided in the accompanying figures. FIGS. 1-7 provide examples if the use of the truncated alphabet representing the 24 letter symbols on a standard telephone keypad. FIGS. 1 and 2 represent the symbols placed on elements having two facets. In FIG. 1, all of the capital letters are separated from the lower case letters. In FIG. 2, the capital and lower case letters are mixed. The elements having all capital letters or having all lower case letters are particularly useful for combinations with other sets carrying other indicia thereon, since they offer a full set of indicia thereon. FIGS. 3-7 show similar sets of elements having English language symbols thereon, however in these figures, the elements have four facets, six facets, eight facets, twelve facets, and twenty-four facets, respectively.

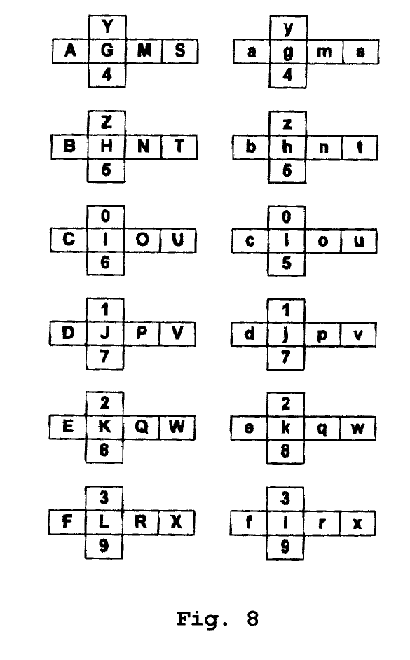

FIG. 8 provides a set utilizing a combination of indicia on several elements. In this case English letter and the number set 0-9 are utilized. The letters and numbers have been placed on the elements in a sequence such that the first letter is on the first element, the second letter is on the second element, the third letter is on the third element and so on until one letter is on each element, then the pattern is restarted with the next letter on the first element and so on.

Additionally, the letters of a second language may be transliterations of the letters that are different from those in the first. For example, with respect to a first language of English and a second language of Spanish, symbols such as the letter “ñ/Ñ” utilized in the Spanish language may be represented as “NY” on an element and the rolled “r” sound in Spanish may be represented as “rr/RR” on an element. Further, other suitable sets include phonetic or phonological indicia commonly used in linguistics and language translations may be utilized to form codes, passwords, time calculation, and the like.

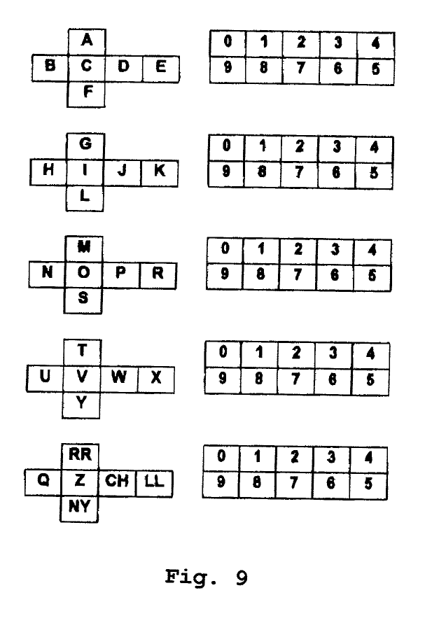

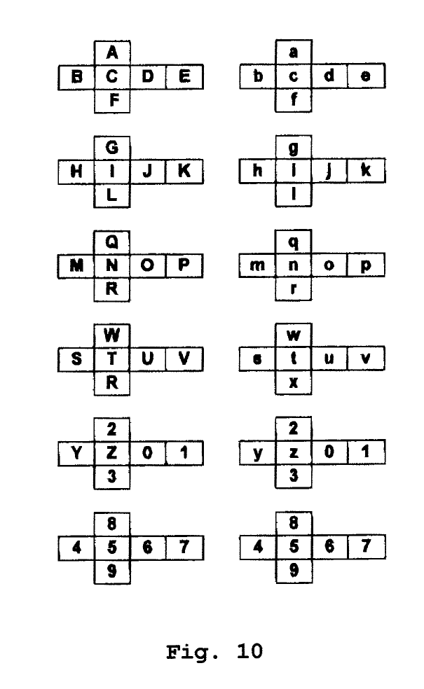

FIG. 9 provides an example of such a set, wherein a set having the full English alphabet and transliterations of the specialized letters of the Spanish alphabet on one set of elements and a set of elements each carrying the 0-9 number set is shown. FIG. 10 provides a set of elements having the full alphabet and the 0-9 number set combined thereon.

Another suitable set includes the indicia on a keyboard such as those on typewriters, computers, and the like. Keyboards represent a closed set of indicia typically comprising letters, numbers, and symbols. Keyboards vary in the number of indicia, the type of indicia, the language used, etc., so there are many suitable sets of this type. From these general sets, narrower sets may be defined for use in specific applications by the administrative entities who define the permissible characters for passwords, codes, PIN's, or other such applications. Non-alpha/numeric symbol sets are also suitable for the present invention. For example, a set used by computer administrators and users includes the symbols: ‘˜!@#$%ˆ &*( )_+−={ }|[ ]\:”;'<>?,./ . These and other similar sets may be useful for computer applications and the like.

Depending upon the application, it may be preferred that one set of indicia be isolated from another set of indicia on separate elements. In that way a single set of indicia may be utilized separately, if necessary.

In one example of the present invention, the first indicia are from the group of symbols consisting of: the 24 letter symbols present on a standard telephone keypad wherein a first element having six facets and third, fourth, and fifth six-faceted elements each carry a portion of the set of the first set of indicia thereon. The first, third, fourth, and fifth elements all have different portions of the first indicia thereon in order to provide a complete set of the 24 characters (4 elements each having 6 facets=24 total facets). This set of elements may also include an element having the second set of indicia thereon that are some or all numeric symbols.

Other embodiments of the invention comprise elements having at least some of the first indicia from the group of symbols including a combination of both the specialized letter symbols present in a second language, such as the Spanish language (or transliterations thereof) and the letter symbols of a first language, such as the English language. This embodiment may also be comprised of elements having at least some second indicia that are numeric symbols.

In order to keep the probability of choosing a first indicia or a second indicia even, one embodiment provides that the ratio of elements having first indicia to elements having second indicia is 1:1. If first indicia are preferred, the present invention provides an embodiment wherein a ratio such as 2:1 is utilized.

Other embodiments of the present invention provide a multi-faceted element or elements that has the entire set of first or of both first and second indicia thereon and the number of facets being such that each facet has an equal surface area, thereby making the probability of all indicia thereon equal. The size of the set of indicia for such designs is largely dependent upon the limited number of element designs wherein the facets have equal surface area. One example of such an element is a twenty-four sided element. Since each facet can have the same shape, each side can have the same area, whereas it is highly unlikely that a twenty-six sided element will have sides with the same shape and consequently will not have all sides with equal area.

Probability can also be controlled by designing element sets wherein each indicia of a set of indicia appears on only one facet of a set of elements. This exists in element sets such as an element having all members of the set of indicia represented once or in sets wherein several elements each have the indicia of the set represented once (such as a design wherein four, six-sided elements have the twenty-four letters of the telephone keypad thereon, wherein each letter is represented on one facet).

Other embodiments of the present invention focus upon the random nature of the indicia on each element. For example, placing the characters in their natural sequential order on the facets of one element and then the next element, or mixing the order of the indicia onto several elements. For example, in six sided elements, the placement of A, B, C, D, E, and F on the first element and G, H, I, J, K, and L on the next element versus a mixed pattern wherein A, G, M, T, B, and H are on the first element.

In order to provide the quick selection of a code sequence, the present invention provides an embodiment wherein the set of elements are constructed and arranged such that the selection of the indicia of a code sequence may be determined through a single manipulation of the elements. For example, if a six digit code is required, a six element set may be provided such that when each element is manipulated, an indicia is selected and, therefore, a manipulation of all elements of the set provides indicia to assemble a six digit code.

Depending upon the particular application for which the code generating system is utilized, in addition to those enumerated above, specialized sets may be created for the particular intended purpose. For example, sets of indicia may be comprised of symbols from groups comprising: the 24 letter symbols present on a standard telephone keypad, a combination of sets such as the set of numeric symbols 0-9 and alphabet symbols, the letter symbols of an alphabet and specialized letter symbols of a second alphabet such as the Spanish alphabet, a computer font or keyboard character set, upper and lower case letter symbols of a case sensitive alphabet, the set of numeric symbols 0-N, wherein N equals a finite integer, upper or lower case letter symbols of a case sensitive alphabet, the set of numeric symbols 0-N, wherein N equals a finite integer, colors, and a combination such as upper or lower case letter symbols of a case sensitive alphabet and colors. The first indicia may be also be comprised of specialized sets such as those provided above. Preferably, a set of elements is comprised of a core set of elements having indicia from a specific set of indicia thereon. Expanded sets of elements carrying different sets of indicia thereon may then be added to the core set to increase the number of possible characters from which the code may be selected.

For example, on such core set may be elements having the entire alphabet thereon. An expanded set to this core set may be elements carrying the set of numbers from 0-9 thereon. A further expansion to the above core and expansion sets may include, for example, the specialized letters of a second alphabet or specific symbols that may be utilized for a specific application.

In applications where capital and lower case letters may be utilized, the present invention includes embodiments having means for determining the upper or lower case letter symbols. The means may be any means known in the art for determining case, for example, color, odd or even numbers, different symbols, such as +/−, and other such means. One such example of how to determine capital letters is to have the several elements holding alphabet indicia also being of different colors. The user may then arbitrarily choose one or more colors that indicate a capital letter. Thus, when the elements are manipulated and indicia are selected, the indicia selected from the particular colored elements will be noted as capitals. Additionally, when using two sets of elements each having different sets of indicia thereon. The sets may be designed such that each element in one set has an element in the other set that matches in color. If the first set has letter indicia thereon, the second set may be used to define the capitalization, For example, with a letter set and a number set, the letter set determines the code and the number set determines the capitalization of the letters by odd-even differentiation.

Embodiments of the present invention can provide many different functions. For example, the present invention can create codes of one, two, or three types of indicia (i.e. letters, numbers, and symbols), can determine capitalization of letter indicia, can determine the order of the chosen indicia, and so on.

In addition to the use of the present invention to formulate codes and passwords, the invention may be utilized to perform general randomization of information or activities. One example of a suitable application with regard to the randomization of activities would be in the initiation of a random event, such as the randomization of a security patrol sweep. The present invention would allow a security detail to randomly decide when to initiate a new security sweep of an area and may also allow the detail to randomly choose where to begin the sweep, thereby, leaving criminals guessing as to when the detail will be at a particular location. The invention is compact and can be used in a location remote from the security office, so the detail can make its decision in the field. Additionally, the random generation is undeterminable by criminals, so there is no way a sophisticated criminal can predict the pattern.

The present invention may also be utilized as a game for forming words and assessing points for scoring from indicia arranged on a set of multi-faceted elements carrying a plurality of indicia thereon. The game is comprised of a first multi-faceted element carrying first indicia and a second multi-faceted element carrying second indicia thereon. The first indicia include at least some language letter symbols. The second multi-faceted element carries second indicia whereby an amount of points can be assigned by the indicia.

The game may have any number of rules variations, but generally, the rules provide that an individual, as either a player or someone who controls the rolls for all players, manipulates the elements to select at least one first and one second indicia. The second indicia is utilized to assign a value to the first indicia. Alternatively, the value may be pre-assigned and, thereby, the use of second indicia is eliminated. From the results of the turn, an individual player can attempt to spell a word using the first indicia. If a word cannot be spelled given the indicia, then the individual passes to another player to allow them to manipulate the elements, or if playing alone, takes another turn.

When an individual takes a second turn, a second first and second indicia are selected and a value is assigned to the first indicia selected on this turn. From the combination of the first indicia from the results of the first and second turns, the individual attempts to spell a word. If none can be spelled, then the individual passes again. When a word is spelled, the individual accrues the points assigned to each of the indicia used to spell the word. This process continues until a word is spelled or until words are spelled equaling a preset total points value.

The game may also feature degrading assigned points. For example, two elements are manipulated and the letter “A” and number “6” are obtained. Since the letter “A” cannot be utilized to spell a word, a second manipulation must occur to obtain a letter to combine with the letter “A”. On the second manipulation an “S” and a “3” are obtained. Under the non-degrading system, the word “as” can be spelled and the values 6 and 3 can be combined, in this example, by means of addition to equal 9. Under a degrading system, wherein each value is reduced by one point per each round the letter is unused, the value of the letter “A” is reduced from 6 to 5 since it could not be used in the first round, and therefore, the total for the word “as” is 8(5+3). Preset values may also be utilized in a degrading format. Additionally, capitalization may be utilized through selection of case by colors, numbers, and other methods of differentiation.

Although the present invention has been described with reference to preferred embodiments, workers skilled in the art will recognize that changes may be made in form and detail without departing from the spirit and scope of the invention. Additionally, since many possible embodiments may be made of the present invention without departing from the scope thereof, it is to be understood that all matter herein set forth or shown in the accompanying drawings is to be interpreted in the illustrative and not a limiting sense.

That which is claimed is:

1. A random multi-character code generating set of multi-faceted elements carrying a plurality of indicia thereon, comprising;
a first multi-faceted element carrying first indicia; and
a second multi-faceted element carrying second indicia distinguishable from first indicia.

2. A set of elements according to claim 1, wherein said at least some of first indicia are alphabet symbols and some of said second indicia are numeric symbols.

3. A set of elements according to claim 1, wherein all of first indicia are alphabet symbols and all said second indicia are numeric symbols.

4. A set of elements according to claim 1, wherein first indicia are from the group of symbols consisting of: the 24 letter symbols present on a standard telephone keypad.

5. A set of elements according to claim 4, wherein said first element has six facets and wherein said set of elements further comprises third, fourth, and fifth six-faceted elements each carrying a portion of said set of first set of indicia thereon, and wherein first, third, fourth, and fifth elements all have different portions of first indicia thereon.

6. A set of elements according to claim 4, wherein at least some of said second indicia are numeric symbols.

7. A set of elements according to claim 4, wherein the total number of facets for all multi-faceted elements is equal to 24.

8. A set of elements according to claim 4, wherein the total number of facets for all multi-faceted elements having first indicia thereon is equal to 24.

9. A set of elements according to claim 8, wherein the total number of facets for all multi-faceted elements having second indicia thereon is equal to 10.

10. A set of elements according to claim 8, wherein the total number of facets for all multi-faceted elements having second indicia thereon are multiples of 10.

11. A set of elements according to claim 1, wherein said at least some of first indicia are from the group of symbols consisting of: the specialized letter symbols present in a second language and the letter symbols of a first language.

12. A set of elements according to claim 11, wherein said first element has six facets and wherein said set of elements further comprises third, fourth, and fifth six-faceted elements each carrying a portion of said set of first set of indicia thereon, and wherein first, third, fourth, and fifth elements all have different portions of first indicia thereon.

13. A set of elements according to claim 11, wherein the total number of facets for all multi-faceted elements is equal to 30.

14. A set of elements according to claim 11, wherein the total number of facets for all multi-faceted elements having first indicia thereon is equal to 30.

15. A set of elements according to claim 14, wherein the total number of facets for all multi-faceted elements having second indicia thereon is equal to 50.

16. A set of elements according to claim 11, wherein at least some of said second indicia are numeric symbols.

17. A set of elements according to claim 1, wherein said set further comprises a third multi-faceted element carrying a portion of said set of first set of indicia thereon, and wherein said portion of said set of indicia on said first element is different from said portion of said set of indicia on said third element.

18. A set of elements according to claim 1, wherein said set further comprises third and fourth multi-faceted elements each carrying a portion of said set of first set of indicia thereon, and wherein first, third, and fourth elements all have different portions of first indicia thereon.

19. A set of elements according to claim 1, wherein the total number of facets for all multi-faceted elements is equal to 26.

20. A set of elements according to claim 1, wherein the total number of facets for all multi-faceted elements is equal to 30.

21. A set of elements according to claim 1, wherein the total number of facets for all multi-faceted elements is equal to 32.

22. A set of elements according to claim 1, wherein the total number of facets for all multi-faceted elements is equal to 34.

23. A set of elements according to claim 1, wherein the total number of facets for all multi-faceted elements is equal to 36.

24. A set of elements according to claim 1, wherein the total number of facets for all multi-faceted elements is equal to 40.

25. A set of elements according to claim 1, wherein the total number of facets for all multi-faceted elements is equal to 80.

26. A set of elements according to claim 1, wherein the ratio of the number of elements having first indicia and elements having second indicia is 1:1.

27. A set of elements according to claim 1, wherein the ratio of the number of elements having first indicia and elements having second indicia is 2:1.

28. A set of elements according to claim 1, wherein the first set of indicia includes all of the letter symbols of an alphabet and wherein the number of said multi-faceted elements having first indicia thereon is such that each of said letter symbols is placed on facets having the same number of edges and said facets having equal surface area.

29. A set of elements according to claim 1, wherein first indicia are from the group of symbols consisting of: the 24 letter symbols present on a standard telephone keypad, the set of numeric symbols 0-9 and alphabet symbols, the letter symbols of a first alphabet and specialized letter symbols of a second alphabet, a keyboard character set, upper and lower case letter symbols of a case sensitive alphabet.

30. A set of elements according to claim 1, wherein first indicia have a predetermined sequential order and wherein said indicia are arranged on said multi-faceted elements such that said portion of first indicia on said first element are the first sequential group equal to the number of facets of said first element.

31. A set of elements according to claim 1, wherein the total number of facets on said set of elements having said first indicia is equal to the number of said first indicia, wherein first indicia have a predetermined sequential order, wherein said elements having first indicia are sequentially ordered, and wherein said indicia are arranged on said multi-faceted elements such that each indicia in sequence is placed on the next element in sequence until all elements have one indicia, the sequence of arrangement is restarted with the first element in sequence such that the next indicia in sequence is arranged on the first sequential element, and so on until all indicia are arranged on said facets.

32. A set of elements according to claim 1, wherein said second indicia are from the group of symbols consisting of: the 24 letter symbols present on a standard telephone keypad, set of numeric symbols 0-9 and alphabet symbols, the letter symbols of a first alphabet and specialized letter symbols of a second alphabet, a keyboard character set, upper and lower case letter symbols of a case sensitive alphabet.

33. A set of elements according to claim 1, wherein first indicia are from the group of symbols consisting of: the 24 letter symbols present on a standard telephone keypad, alphabet symbols, the letter symbols of an alphabet and specialized letter symbols of a second alphabet, a keyboard character set, upper or lower case letter symbols of a case sensitive alphabet.

34. A set of elements according to claim 33, wherein said second indicia are from the group of symbols consisting of: the set of numeric symbols 0-N, wherein N equals a finite integer, upper or lower case letter symbols of a case sensitive alphabet, the set of numeric symbols 0-N, wherein N equals a finite integer and colors, and upper or lower case letter symbols of a case sensitive alphabet and colors.

35. A set of elements according to claim 1, wherein each indicia of said set of first indicia appears on only one facet of said set of elements.

36. A set of elements according to claim 35, wherein each indicia of said second indicia appears on only one facet of said set of elements.

37. A set of elements according to claim 1, wherein said set of first indicia is comprised of letter symbols from a case sensitive alphabet and said set of elements further comprises means for determining the upper or lower case letter symbols.

38. A set of elements according to claim 37, wherein said means for determining said case of said alphabet is provided by said second indicia.

39. A set of elements according to claim 37, wherein said means for determining said case of said alphabet is provided by color indicia.

40. A set of elements according to claim 37, wherein said means for determining said case of said alphabet is provided by said second indicia, wherein said second indicia are numeric symbols and said case of said alphabetic letter symbols is determined by the odd or even result from a selection from said second indicia.

41. A set of elements according to claim 1, wherein each element carrying first indicia is a different color and wherein for each element having first indicia an element carrying second indicia and having the same color is present in the set.

42. A game for forming words and assessing points for scoring from indicia arranged on a set of multi-faceted elements carrying a plurality of indicia thereon, comprising;
a first multi-faceted element carrying first indicia, said at least some of first indicia comprised of language letter symbols; and
means for assigning an initial value to each indicia selected.

43. The game according to claim 42, wherein said means for assigning an initial value is provided by a second multi-faceted element carrying second indicia whereby an amount of points can be assigned by said indicia.

44. A method of playing a game for forming words and assessing points for scoring from indicia arranged on a set of multi-faceted elements carrying a plurality of indicia thereon, the steps comprising;
providing a first multi-faceted element carrying first indicia, at least some first indicia comprised of language letter symbols and a second multi-faceted element carrying second indicia whereby an amount of points can be assigned by said indicia;
manipulating said first element to select an indicia from said first indicia;
manipulating said second element to select an indicia from said second indicia;
assigning points to said indicia of said first element based upon the indicia of the second element.

45. The method according to claim 44, wherein said method is repeated a plurality of times to provide a plurality of indicia for forming words and wherein assigned points are reduced each subsequent time the first element is manipulated.

46. A set of multi-faceted elements each having a plurality of indicia thereon, said set comprising;
two or more first multi-faceted elements carrying first indicia thereon;
one or more second multi-faceted element carrying second indicia thereon; and
means for determining a code sequence comprised of selected indicia from both said first and second indicia.

47. A set of elements according to claim 46, wherein said set of said elements is constructed and arranged such that the selection of said indicia of said code sequence may be determined through a single manipulation of said elements.
